(19) United States
(12) Patent Application Publication
(10) Pub. No.: US 2015/0304431 A1
(43) Pub. Date: Oct. 22, 2015

(54) SYSTEM AND METHOD TO PROVIDE A WIRELESS CONNECTION TO A COMMUNICATION NETWORK AND A PORTABLE COMMUNICATION DEVICE

(71) Applicant: TELEFONICA, S.A., Madrid (ES)

(72) Inventors: Jose Ignacio HONORATO GARCIA, Madrid (ES); David ALONSO RUIZ, Madrid (ES)

(73) Assignee: TELEFONICA, S.A., Madrid (ES)

(21) Appl. No.: 14/646,098

(22) PCT Filed: Nov. 20, 2013
(86) PCT No.: PCT/EP2013/074268

§ 371 Date: May 20, 2015

(30) Foreign Application Priority Data
Nov. 23, 2012 (ES) P201231821

(51) Int. Cl. H04L 29/08; H04W 76/02

(52) U.S. Cl. CPC H04L 67/141; H04W 76/02

(57) ABSTRACT

System and method to provide a wireless connection to a communication network and a portable communication device.

The system comprising a portable communication device having communication capabilities regarding at least a first wireless communication technology and at least a second communication technology; and a computing device having wireless connection capabilities regarding said first wireless communication technology to connect to a network operating at said second communication technology through said portable communication device by connecting thereto via said first wireless communication technology. In the system said portable communication device is connectable to a host port of said computing device by plugging it thereto and arranged to be power supplied through said plugging.

Embodiments of the invention also provide a method to be implemented by the system of the invention and a portable communication device.

### FIELD OF THE ART

The present invention generally relates to wireless communications, and more particularly to a system and method to provide a wireless connection to a communication network.

The invention also relates to a portable communication device having communication capabilities regarding at least two communication technologies to simplify the process of getting connected to a communication network.

### PRIOR STATE OF THE ART

Mobile Broadband is being a common feature on all kind of devices. That means that devices come to the market with an embedded WAN modem, or mobile operators are offering solutions to provide connectivity to all of them.

When a user wants to have a connected device, usually there are two different options:

The first one is to buy a device with WAN embedded. The decision of having WAN connectivity has to be made at purchase time. This means that customers have to decide paying an extra cost (e.g. 100$) for the ability of been able to connect to a mobile operator network. In case not, and in the future will like to have WAN connectivity, the customer may change the device or look for a solution such as follows.

The second one is to buy an accessory to provide WAN connectivity. Here it can be found different solutions, depending on the device, money to spend, portability, etc.:
USB dongle: typically for netbooks/notebooks. Currently drivers and a connection manager application should be installed. Dongles are only compatible with certain OS (Windows and Mac OS).
Mobile hot spot (MiFi®) or equivalent product. Devices that create a WiFi network that customer device will connect to, and connects to WAN network to provide connectivity. This also includes using a smartphone as a hotspot.
USB dongle plus WiFi base. Mixture of previous solutions which result is been connected to WAN via a WiFi network
Specific OEM accessory. Could vary depending on the OEM and the device to be connected. Very specific solution that do not exist for all products.

Patent WO 2010132720 “Systems and Methods for Controlling Device Network Access” describes a wireless router that comprises a WAN radio interface to enable communication between a WAN network and the wireless router, and a LAN radio interface to enable communication between the wireless router and a plurality of computing devices.

Patent U.S. Pat. No. 8,208,517 “Systems and methods for a multi-mode wireless modem” describes a multi-mode modem comprising a first device configured to communicate with a first communication system, a second device configured to communicate with a second communication system, a processor communicatively coupled the first and second devices, and a control function configured to place the device in one of the following communication modes: communication with the first communication system; communication with the second communication system; simultaneous communication with both the first and second communication systems; gateway communication between the first and second communication systems.

The present invention on contrary, targets devices that do not have WAN embedded. It always thinks on providing a portable way of connecting to mobile operator networks.

Regarding existing solutions, they have some limitations that the present invention tries to cover:
USB dongle: This solution widely used on netbooks/notebooks can only be used if the device it wants to be connected is compatible, and is typically based on the OS of the device, Windows or Mac for instance.
   It doesn't work if a different OS (Linux, Android . . . ) is used. The present invention does not have SO limitations, it just needs WiFi on the device to be able to be connected.
   Drivers and applications needed to be installed. The present invention needs neither drivers nor applications.
Mobile hotspot:
   Battery. The device using a mobile hotpot needs to be charged. If it runs out of battery, it is not able to be connected using the standard way it was designed for (via WiFi). The present invention does not need batteries, just uses device battery to be fully operable.
   Get connected. Quite easy from devices such as notebooks and smartphones. In the case a device that may not have an intuitive User Interface (UI) or very specific text input mechanism wants to be connected, typing WiFi credentials may be complex.
   Management. Complex device that allows too many configuration options. The present invention just provides a very easy and intuitive management interface that probably will never has to be used by the customer.
USB dongle plus WiFi base. In addition to problems on Mobile hotspots:
   Only compatible USB dongles can be used on the specific WiFi base. The present invention minimizes HW compatibility problems.
Specific OEM accessory. Not all devices have a WAN modem accessory. The present invention does not have that limitation.

Patents WO 2010132720 and U.S. Pat. No. 8,208,517 do not cover topics such as power supply, physical connections, connection process, management/usability of the device, product design or portably of the solution.

The solution proposed in this invention tries to simplify the process of getting connected to a mobile operator network from any kind of device, with a simple and cost-effective product.

### SUMMARY OF THE INVENTION

The object of the present invention is to provide an intelligent WiFi USB (UiFi) having wide compatibility, an easy connection process and being a cost-effective product.

The UiFi connects to WAN and creates a WiFi network to connect user's device. UiFi is physically connected to user's device via USB (just for power), but WAN network access via WiFi interface.

The invention is a universal solution to provide mobile operator network connectivity to all devices. The device just needs to fulfill two requirements, no needing drivers and or any application:
WiFi supports, because this will be the base technology that allows to be connected to WAN networks.
USB. USB interface just to power the device. No communication interface is needed and/or used.

To that end, the present invention relates, in a first aspect, to a system to provide a wireless connection to a communication network, the system comprising:

a portable communication device having communication capabilities regarding at least a first wireless communication technology and at least a second communication technology; and

a computing device having wireless connection capabilities regarding said first wireless communication technology to connect to a network operating at said second communication technology through said portable communication device by connecting thereto via said first wireless communication technology.

On contrary to the known proposals, an in a characteristic manner, in the system said portable communication device is connectable to a host port of said computing device by plugging it thereto and arranged to be power supplied through said plugging.

The portable communication device is configured to make use of drivers and applications of said computing device.

Preferably, to establish said connection between said portable communication device and said computing device the system receives a broadcasted Service Set Identifier (SSID) and has to have said first wireless communication technology open.

In an embodiment, said connection can be established automatically just after said plugging or can be configured to be established within at least a few seconds after said plugging, for instance, to be established between 10 and 15 seconds.

The portable communication device is further configured to work at a minimum transmission power, because the distance between both devices will be very close.

Moreover, the portable communication device is configured to be limited to a single MAC address.

In another embodiment, in order to have more secure connections, the SSID can be readable on said portable communication device.

In yet another embodiment, the portable communication device can be used as an entry level product for a HSPA network, as a medium level product for a HSPA+and/or a Dual Cell network and/or as a premium level product for a LTE network or any other future network technology.

The present invention, in a second aspect relates to a method to provide a wireless connection to a communication network, comprising:

a portable communication device having communication capabilities regarding at least a first wireless communication technology and at least a second communication technology; and

connecting a computing device having wireless connection capabilities regarding said first wireless communication technology through said portable communication device thereto via said first wireless communication technology to a network operating at said second communication technology.

The method on contrary to the known proposals comprising connecting said portable communication device to a host port of said computing device by plugging it thereto and power supplying said portable communication device by means of said plugging.

The portable communication device automatically connect said computing device through said network operating at said second communication technology if said network operating at said second communication technology has a SIM PIN deactivated.

On another hand, when said portable communication device connects for a first time said computing device to said network operating at said second communication technology and in case said network operating at said second communication technology has an activated SIM PIN, comprises triggering a web page through an user interface to introduce a SIM PIN of said network operating at said second communication technology and further remembering said network operating at said second communication technology SIM PIN for further connections.

In case the network operating at said second communication technology is SIM PIN protected said SIM PIN is used as a key protection of said first wireless communication technology. In this case, the PIN only needs to be introduced once and the device can connect to secure WiFi network and also unlocks the SIM and register to the operator network.

The invention in a third aspect relates to a portable communication device, comprising communication capabilities regarding at least a first wireless communication technology and at least a second communication technology, said portable device being used, by a computing device having wireless connection capabilities regarding said first wireless communication technology, to connect, via said first wireless communication technology, to a network operating at said second communication technology. The portable communication device is connectable to a host port of said computing device by plugging it thereto and arranged to be power supplied through said plugging.

The portable communication device of the third aspect of the present invention has two different indicators, a first one of said two different indicators used for indicating said first wireless communication technology and a second one of said two different indicators used for indicating said second communication technology. Furthermore, it uses a VCC pin and a GND pin for said power supplied.

In an embodiment, the portable communication device of the invention is a Universal Serial Bus (USB) device, and said network operating at said second communication technology is a wide area network.

### BRIEF DESCRIPTION OF THE DRAWINGS

The previous and other advantages and features will be more fully understood from the following detailed description of embodiments, with reference to the attached, which must be considered in an illustrative and non-limiting manner, in which:

FIG. 1 and FIG. 2 are two illustrations of the UiFi device proposed in the invention.

### DETAILED DESCRIPTION OF SEVERAL EMBODIMENTS

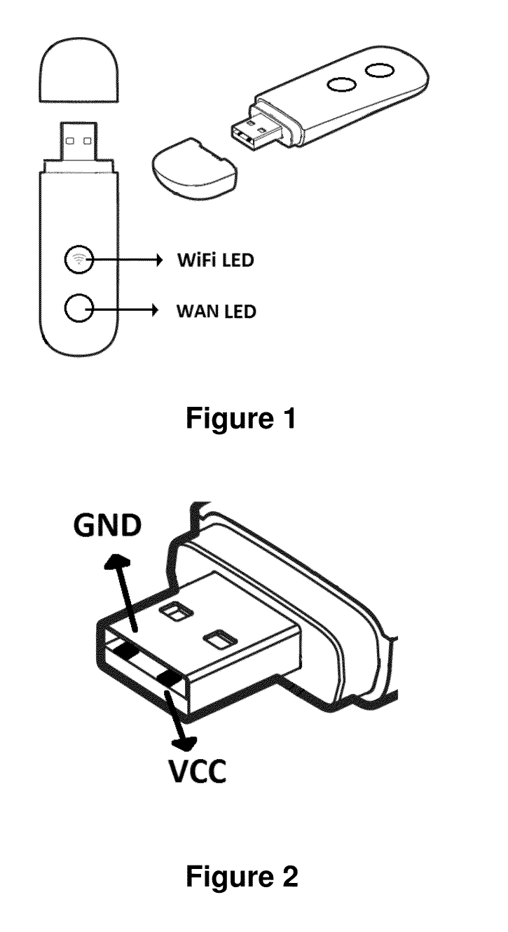

The present invention has a similar ID such as a standard USB dongle, but open for new form factors. As can be seen in FIGS. 1 and 2 the device has two different LED indicators, one for WAN status and one for WiFi status. USB connector only needs two out of four standard pins: VCC and GND.

The invention works as follows, a user plugs UiFi device on a USB host port of the WiFi-enabled device that wants to be connected to Internet. Then, UiFi is powered through USB interface (only VCC and GND pins needed) and connects to WAN network automatically and radiates WiFi network. Finally, WiFi-enabled device connects to WiFi network and WiFi-enabled device is connected.

The invention has some unique particularities, not only in HW side (including WAN and WiFi on a single USB dongle), but also on the connection process and simplicity.

For example, UiFi network (WiFi network created by UiFi device) only allows connecting one single device at any time. That means only the device where the UiFi is plugged will have access to WAN network. This work operation is like a standard “3G USB dongle” having connectivity only where the dongle is plugged.

Technically there can be four main scenarios:
SSID broadcasted and WiFi network open.
SSID not broadcasted and WiFi network open.
SSID broadcasted and WiFi network protected.
SSID not broadcasted and WiFi network protected.

Increasing the security also increases the complexity for been connected. For UiFi it is recommended the first scenario, SSID broadcasted and WiFi network open, less secure but extremely easy to get connected, although any other alternative scenario could be also possible. For instance, in previous scenarios in which the WiFi network is protected, an embodiment of the invention includes a mechanism in which the own SIM PIN can also serve as key WiFi. So the system only prompts the introduction of the PIN once and, thereby, the device can connect to secure WiFi network and also unlocks the SIM and register to the operator network. To provide a reasonable level of security with the simplest user experience, the invention would implement three mechanisms:
Power radiated. As the device will be physically connected via USB, the transmission power will be reduced to the minimum level. So it will be hard to intercept WiFi transmission by a third party unless is very close (e.g. less than 1 meter).
Single user. As described before, the invention substitutes standard USB data interface (one-to-one connection) by WiFi interface.
Time frame to connect. WiFi-enabled device could establish WiFi connection during a delimited time frame.

As the UiFi device will transmit using very low power, because the device will be very close (just centimetres) it has no need to create an extended WiFi area. This allows that downloading channel, the one that will have more traffic will not be detected by third parties.

There can be several ways to implement the single user mechanism:
Configuring WiFi interface to allow only one single user.
Limiting WiFi interface to only one MAC address. This is the preferable solution:
   In case user's device disconnects from WiFi network, not other WiFi device will be able to connect to.
   MAC address restriction is setup during connection process. MAC address is obtained from the first device gets connected first, and will remain until UiFi device is powered off (disconnected from USB port).

On the other hand, in the time frame to connect mechanism, the WiFi connection process starts when UiFi is plugged. WiFi-enabled device would have only few seconds (10-15 sec) to connect to. In case UiFi does not receive any connection request, WiFi is disabled. This mechanism limits the probability that a third party connects to UiFi device, as only have few seconds to connect to, and do not know when time period start (when UiFi device plugged).

These three mechanisms are complementary and should be used simultaneously to provide extra security to the connection between UiFi and user's WiFi enabled device.

Other approaches could be implemented, more secure but hardest to the user to be able to get connected, or needing something more from WiFi-enabled device (e.g. WPS support). SSID would be readable on UiFi device.

UiFi device automatically connects to WAN network when powered on:
Seamless, in case SIM PIN deactivated.
User forwarded to UiFi's web page where introduce SIM PIN the first time the UiFi is used. PIN will be remembered for following accesses, so users will not be redirected again to the webpage to introduce PIN.

Some of the advantages of the present invention are:

It is easy to use due to no drivers and/or no applications are needed and the connection process is extremely simple.

It is universal, regardless of the OS.

Cost-effective, fewer components (no battery, simplest application processor . . . ).

Depending on mobile network connectivity, the invention can be created as an entry level product (HSPA), medium (HSPA+, Dual Cell) or premium (LTE, or any other future network technology).

Although certain specific construction examples have been described and illustrated, an expert in the material would be able to introduce multiple variations to these without leaving the scope of the invention, which is defined by the attached claims.

### ACRONYMS

### LAN Local Area Network

### OS Operative System

### SSID Service Set Identifier

UiFi USB intelligent WiFi

### WAN Wide Area Network

WPS WiFi Protected Setup

1-15. (canceled)

16. A system to provide a wireless connection to a communication network, comprising:
a portable communication device having communication capabilities regarding at least a first wireless communication technology and at least a second communication technology; and
a computing device having wireless connection capabilities regarding said first wireless communication technology to connect to a network operating at said second communication technology through said portable communication device by connecting thereto via said first wireless communication technology,
said portable communication device being connectable to a host port of said computing device by plugging it thereto and being arranged to be power supplied through said plugging; and wherein the portable communication device is configured to:
make use of drivers and applications of said computing device;
work at a minimum transmission power and be limited to a single MAC address; and
be used by the computing device to perform said connection to said network operating at the second communication technology only for a few seconds after said plugging, wherein to establish said connection a broadcasted Service Set Identifier (SSID) is used and said first wireless communication technology is open.

17. The system according to claim 16, wherein said connection is configured to be established automatically just after said plugging.

18. The system according to claim 16, wherein said few seconds comprises a time frame between 10 to 15 seconds.

19. The system according to claim 16, wherein said SSID is readable in said portable communication device.

20. The system according to claim 16, wherein said portable communication device is used as an entry level product for a HSPA network, as a medium level product for a HSPA+ and/or a Dual Cell network and/or as a premium level product for a LTE network.

21. The system according to claim 16, wherein said portable communication device is a Universal Serial Bus, USB, device.

22. The system according to claim 16, wherein said network operating at said second communication technology is a wide area network.

23. A method to provide a wireless connection to a communication network, wherein a portable communication device has communication capabilities regarding at least a first wireless communication technology and at least a second communication technology, the method comprising:
connecting said portable communication device to a host port of a computing device by plugging it thereto, the portable communication device being power supplied by means of said plugging and the computing device having connection capabilities regarding the first wireless communication technology; and
connecting the computing device, through said portable communication device, via said first wireless communication device, to a network operating at said second communication technology; and
wherein the portable communication device uses drivers and applications of said computing device, works at a minimum transmission power and is limited to a single MAC address, and is used by the computing device to perform said connection to said network operating at the second communication technology only for a few seconds after said plugging, and in that the method comprises having the first wireless communication technology open and using a broadcasted Service Set Identifier (SSID) to establish said connection between the portable communication device and the computing device.

24. The method according to claim 23, wherein said portable communication device automatically connects said computing device through said network operating at said second communication technology if said network operating at said second communication technology has a deactivated SIM PIN.

25. The method according to claim 23, wherein when said portable communication device connects for a first time said computing device to said network operating at said second communication technology comprises triggering a web page through an user interface to introduce a SIM PIN of said network operating at said second communication technology.

26. The method according to claim 25, comprising remembering said network operating at said second communication technology SIM PIN for further connections.

27. The method according to claim 23, wherein if said network operating at said second communication technology is SIM PIN protected comprises using said SIM PIN as a key protection of said first wireless communication technology.

28. A portable communication device, comprises:
communication capabilities regarding at least a first wireless communication technology and at least a second communication technology,
is connectable to a host port of a computing device having wireless connection capabilities regarding said first wireless communication technology by plugging it thereto and arranged to be power supplied through said plugging; and
is configured to be used by the computing device to connect the computing device, via said first wireless communication device, to a network operating at said second communication technology; and
the portable communication device is configured to:
make use of drivers and applications of said computing device;
work at a minimum transmission power and be limited to a single MAC address; and
be used by the computing device to perform said connection to said network operating at the second communication technology only for a few seconds after said plugging, wherein to establish said connection a broadcasted Service Set Identifier (SSID) is used and said first wireless communication technology is open.

29. The portable communication device according to claim 28, comprising two different indicators, a first one of said two different indicators used for indicating said first wireless communication technology and a second one of said two different indicators used for indicating said second communication technology.

30. The portable communication device according to claim 29, using a VCC pin and a GND pin for said power supplied.
